(19) United States
(12) Patent Application Publication
(10) Pub. No.: US 2024/0041573 A1
(43) Pub. Date: Feb. 8, 2024

(54) METHODS AND SYSTEMS FOR AFFIXING HARDWARE TO 3D-PRINTED DENTAL APPLIANCES

(71) Applicant: Great Lakes Dental Technologies, Ltd., Tonawanda, NY (US)

(72) Inventor: Tyler Sisson, Buffalo, NY (US)

(21) Appl. No.: 18/365,896

(22) Filed: Aug. 4, 2023

Related U.S. Application Data
(60) Provisional application No. 63/370,444, filed on Aug. 4, 2022.

(51) Int. Cl. A61C 13/00; B33Y 10/00

(52) U.S. Cl. CPC A61C 13/0019; B33Y 10/00

(57) ABSTRACT

A boss assembly for attachment of hardware components to a dental appliance includes an anchor configured to be disposed on an external side of a dental appliance. The anchor has first internal threads on a proximal end and second internal threads on a distal end. The second internal threads are configured to cooperate with external threads of hardware components to be attached. A stud is configured to be disposed on an internal side of a dental appliance. The stud includes a flange on a proximal end and external threads configured to cooperate with the first internal threads of the anchor. The anchor and the stud are configured to join such that a wall of the dental appliance is captured between the anchor and the flange of the stud.

### CROSS-REFERENCE TO RELATED APPLICATIONS

This application claims priority to U.S. Provisional Application No. 63/370,444, filed on Aug. 4, 2022, now pending, the disclosure of which is incorporated herein by reference.

### FIELD OF THE DISCLOSURE

The present disclosure relates to dental appliances, and more particularly to 3D-printed dental appliances having components mechanically affixed.

### BACKGROUND OF THE DISCLOSURE

Dental appliances are typically made from plastics which are made by molding, thermoforming, etc. Such appliances often incorporate metal components (e.g., hinges, etc.) which are welded to a metal substructure of the appliance (see FIGS. 1 and 2). Recent advances in additive manufacturing and design allow for the production of custom appliances by 3D printing. However, such custom appliances may not have metal substructures to which metal components can be welded. The trays of such 3D printed appliances may have thin walls which do not have sufficient strength for direct attachment of such components.

There is a need for techniques which allow for the mechanical attachment of a component, for example, a metal component, to a tray of a dental appliance.

### BRIEF SUMMARY OF THE DISCLOSURE

In a first aspect, the present disclosure may be embodied as a 3D-printed dental appliance (such as, for example, a Herbst appliance). The appliance includes a first appliance tray configured to cover at least a portion of a first dental arch of an individual. The first appliance tray may have a protrusion at a hardware attachment location. A first stud is disposed on an internal side of the first appliance tray. The first stud has a flange on a proximal end and external threads disposed through a hole of the first appliance tray (for example, of the protrusion). A first anchor is disposed on an external side of the first appliance tray, the first anchor having first internal threads on a proximal end engaged with the external threads of the first stud. In this way, a portion of the first appliance tray (e.g., of the protrusion) is captured between the flange of the first stud and the first anchor. The first anchor and/or the first stud may be made from a plastic (e.g., nylon, etc.), a metal, or a composite. The first anchor includes second internal threads on a distal end. The 3D-printed dental appliance may include a first fastener joined with the second internal threads of the first anchor. In some embodiments, the external threads of the first stud and/or the first internal threads of the first anchor include an adhesive.

In some embodiments, the 3D-printed dental appliance includes a second appliance tray configured to cover at least a portion of a second dental arch of an individual. The second appliance tray having a protrusion at a hardware attachment location (i.e., a hardware attachment location of the second appliance tray). A second stud is disposed on an internal side of the second appliance tray. The second stud has a flange on a proximal end and external threads disposed through a hole of the second appliance tray (for example, of the protrusion). A second anchor is disposed on an external side of the second appliance tray, the second anchor having first internal threads on a proximal end engaged with the external threads of the second stud. In this way, a portion of the second appliance tray (e.g., of the protrusion) is captured between the flange of the second stud and the second anchor. The second anchor and/or the second stud may be made from a plastic (e.g., nylon, etc.), a metal, or a composite. The second anchor includes second internal threads on a distal end. The 3D-printed dental appliance may include a second fastener joined with the second internal threads of the second anchor. In some embodiments, the external threads of the second stud and/or the first internal threads of the second anchor include an adhesive.

In some embodiments, a hardware component is connected to the first appliance tray and the second appliance tray by way of the first anchor and first fastener and the second anchor and second fastener.

In another aspect, the present disclosure may be embodied as a boss assembly for attachment of hardware components to a dental appliance. The boss assembly includes: an anchor configured to be disposed on an external side of a dental appliance, the anchor having first internal threads on a proximal end, and second internal threads on a distal end, and wherein the second internal threads are configured to cooperate with external threads of a hardware component; a stud configured to be disposed on an internal side of a dental appliance, the stud having a flange on a proximal end and external threads configured to cooperate with the first internal threads of the anchor; and wherein the anchor and the stud are configured to join such that a wall of the dental appliance is captured between the anchor and the flange of the stud.

In another aspect, the present disclosure may be embodied as a method of securing a hardware component to a 3D printed dental appliance. The method includes: disposing a first stud through a hole of a first appliance tray such that a flange of the first stud is on an internal side of the first appliance tray; screwing a first internal thread of a first anchor on an external side of the first appliance tray to an external thread of the first stud such that a portion of the first appliance tray is captured between the first anchor and the flange of the first stud; and affixing a first end of a hardware component to the first anchor using a first fastener secured to a second internal thread of the first anchor.

In some embodiments, the method further includes: disposing a second stud through a hole of a second appliance tray such that a flange of the second stud is on an internal side of the second appliance tray; screwing a first internal thread of a second anchor on an external side of the second appliance tray to an external thread of the second stud such that a portion of the second appliance tray is captured between the second anchor and the flange of the second stud; and affixing a second end of the hardware component to the second anchor using a second fastener secured to a second internal thread of the second anchor.

### DESCRIPTION OF THE DRAWINGS

For a fuller understanding of the nature and objects of the disclosure, reference should be made to the following detailed description taken in conjunction with the accompanying drawings, in which:

FIG. 1 is an illustration of a prior art dental appliance;

FIG. 2 is an illustration of typical hardware components for a Herbst appliance, including (from top to bottom) screws, pivots, and pistons;

FIG. 3 is an illustration of a dental appliance incorporating an embodiment of the present disclosure;

FIG. 4 is a detailed view of a portion of the dental appliance shown in FIG. 3;

FIG. 5 is a diagram showing the unassembled components of the present disclosure;

FIG. 6 is a diagram showing the components of FIG. 5 assembled around a portion of an appliance;

FIG. 7 is a diagram showing the assembled components of FIG. 6 along with additional hardware to be affixed to the assembled components;

FIG. 8 is a diagram showing the hardware of FIG. 7 affixed to the assembled components;

FIG. 9 shows an upper tray and a lower tray of a dental appliance;

FIG. 10 depicts another embodiment of a dental appliance; and

FIG. 11 is a chart showing a method according to an embodiment of the present disclosure.

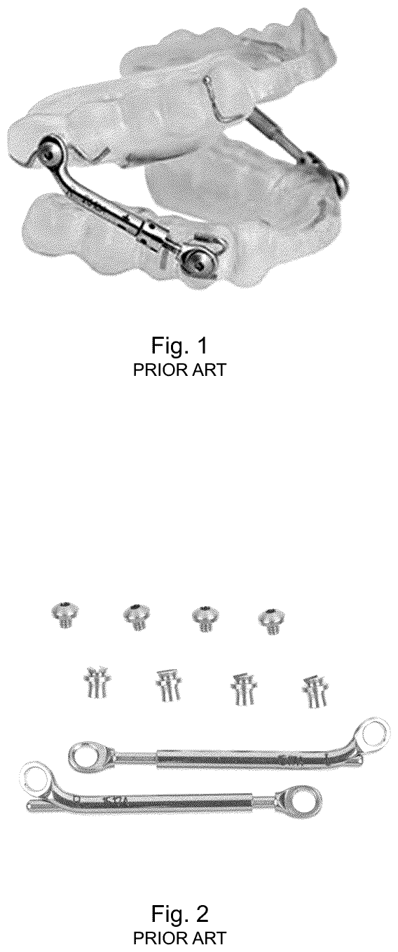

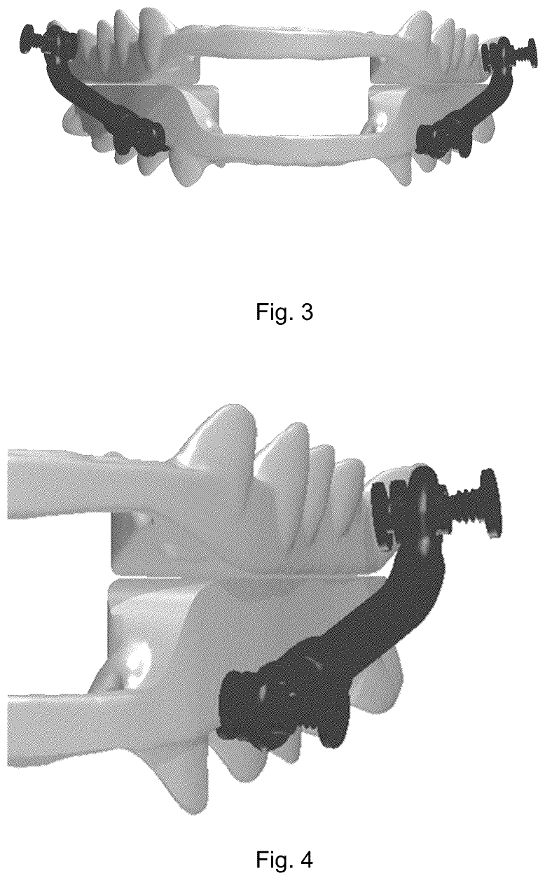

### DETAILED DESCRIPTION OF THE DISCLOSURE

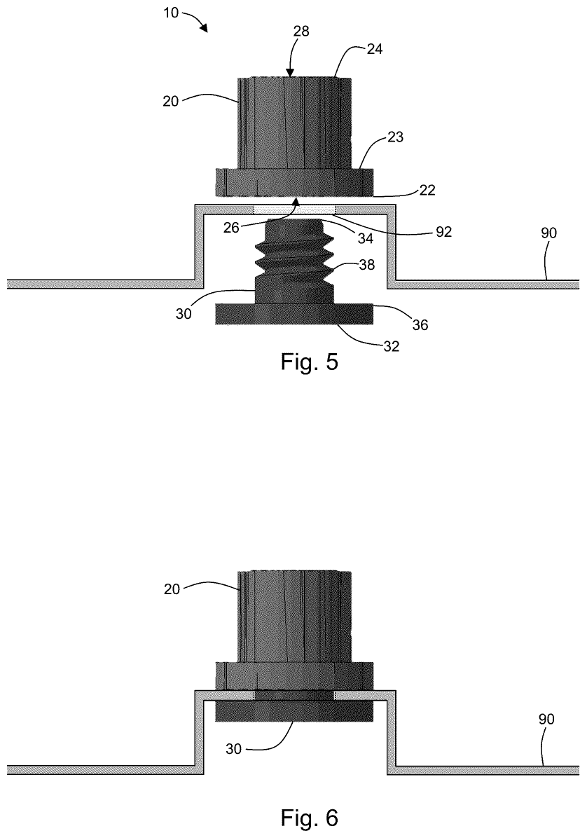

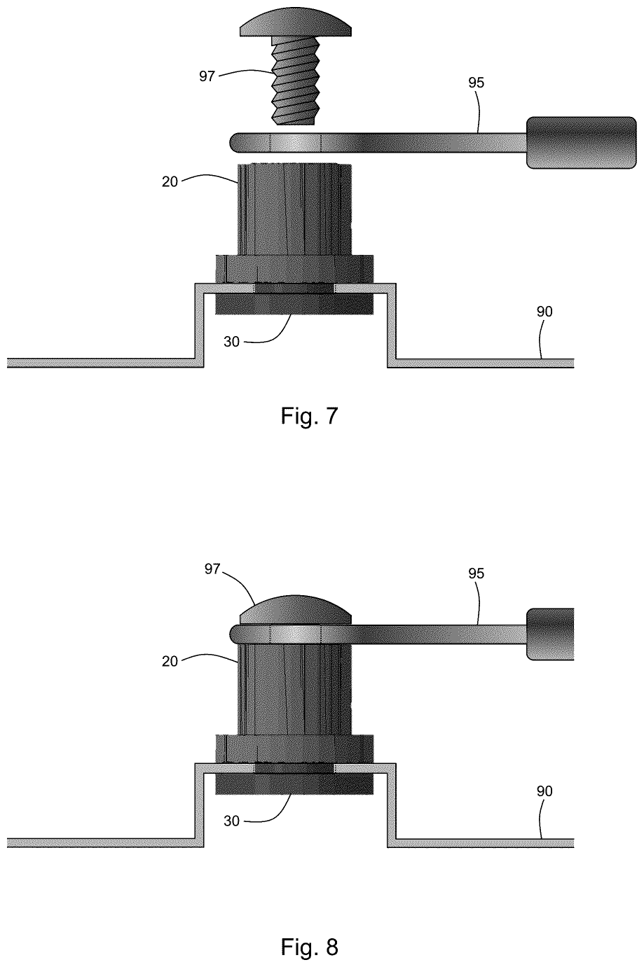

With reference to FIGS. 5-8, the present disclosure may be embodied as a boss assembly 10 for attachment of hardware components to a dental appliance. The hardware components may be metal components, but may be made from other materials instead of or in addition to metal. An example of a dental appliance is a Herbst® appliance. FIG. 5 shows a boss assembly 10 having an anchor 20 and a stud 30.

The anchor 20 has a proximal end 22 and a distal end 24. The proximal end 22 has first internal threads 26. The distal end 24 has second internal threads 28. The first internal threads are configured to cooperate with (i.e., receive) external threads of the stud (described below). The second internal threads are configured to cooperate with (i.e., receive) the external threads of the hardware component to be attached. For example, the hardware component may be a hinge having a piston 95 attached with a screw 97. In other examples, the hardware component may be a linkage, a strut, a spring, rod, a shaft, a crossbar, or any other member. The proximal end of the anchor is configured to be disposed on an external side of a dental appliance. In some embodiments, such as that illustrated in FIGS. 5-8, the proximal end 22 of the anchor 20 includes a flange 23. FIGS. 5 and 6 show a portion of a wall 90 of a dental appliance against which the anchor 20 is placed.

The stud 30 has a proximal end 32 and a distal end 34. The stud is configured to be disposed on an internal side of the dental appliance. For example, the proximal end 32 of the stud 30 depicted in the figures has a flange 36 configured to be disposed on the internal side of the wall 90 of the dental appliance. The stud 30 includes external threads 38 configured to cooperate with the first internal threads 26 of the anchor 20. In this way, when the stud is disposed through a hole 92 of the dental appliance, the external threads 38 are received by the first internal threads of the anchor 20. The anchor and the stud are configured to join such that a wall of the dental appliance is captured between the anchor and the flange of the stud. In some embodiments, such as some embodiments where the dental appliance includes trays that are configured to fit on (cover) a dental arch of a person, the internal side may refer to a side of the tray which is adjacent to the dental arch (i.e., the tooth-side) and the external side may refer to a side of the tray which is opposite the tooth side of the tray (see, for example, FIG. 10).

The anchor and the stud may be made from plastic, metal, composites, or another material or combinations of materials. The material of the anchor may be the same as or different from the material of the stud. For example, the anchor and/or the stud may be made from nylon or another plastic. The material of the boss assembly may be the same as or different from the material of the dental appliance. For example, the dental appliance may be 3D printed using nylon, a different plastic, and/or a different material other than plastic, and the boss assembly may be made from nylon, a different plastic, and/or a different material other than plastic. The anchor and the stud may be made using known techniques, such as, for example, injection molding, machining, additive manufacturing, etc.

In some embodiments, the anchor includes a plurality of side walls configured to accept a tool. For example, the anchor may have side walls configured to accept a wrench, a socket, a nut driver, etc. The stud, for example, the flange of the stud, may have a plurality of side walls configured to accept a tool, such as an assembly tool (e.g., wrench, socket, nut driver, etc.) In some embodiments, the proximal end of the stud includes a shaped cavity configured to accept a drive tool. For example, the proximal end of the stud may be shaped to accept a Phillips driver, an Allen driver, a slotted driver, a Torx driver, etc.

In some embodiments, the external threads of the stud include an adhesive (e.g., on a surface of at least a portion of the external threads). In some embodiments, the first internal threads of the anchor include an adhesive (e.g., on a surface of at least a portion of the internal threads). In some embodiments, both the external threads of the stud and the first internal threads of the anchor include an adhesive. The adhesive may be reversible or irreversible. By irreversible, it is meant that the stud and/or the anchor would be damaged if the cooperating threads were separated (or attempted to be separated). In some embodiments, the adhesive is a thread-locking fluid. In some embodiments, the adhesive is a cement used to solvent weld the threads together. Other single-component or multi-component adhesives may be used.

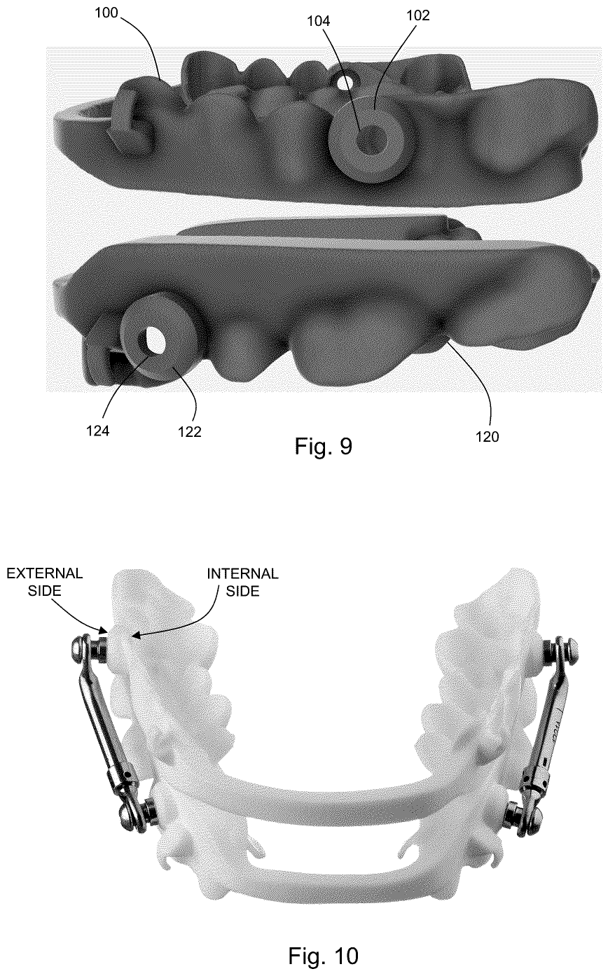

In another aspect, the present disclosure may be embodied as a 3D-printed dental appliance. The dental appliance includes a first appliance tray configured to cover at least a portion of a first dental arch of an individual. FIG. 9 depicts an example of a first appliance tray 100. The first appliance tray includes a protrusion 102 at a hardware attachment location. The dental appliance includes a boss assembly similar to that described above. A first stud is disposed on an internal side of the protrusion 102 of the first appliance tray 100. The first stud includes a flange on a proximal end and external threads that are disposed through a hole 104 of the protrusion 102. A first anchor is disposed on an external side of the protrusion 102. The first anchor includes first internal threads on a proximal end engaged with the external threads of the first stud such that a portion of the protrusion 102 is captured between the flange of the first stud and the first anchor. The first anchor includes second internal threads on a distal end. In some embodiments, a fastener may be joined with the second threads of the first anchor.

In some embodiments, the 3D-printed dental appliance further comprises a second appliance tray, such as second appliance tray 120 of FIG. 9. The second appliance tray includes a protrusion 122 at a hardware attachment location. The dental appliance includes a boss assembly similar to that described above. A second stud is disposed on an internal side of the protrusion 122 of the second appliance tray 120. The second stud includes a flange on a proximal end and external threads that are disposed through a hole 124 of the protrusion 122. A second anchor is disposed on an external side of the protrusion 122. The second anchor includes first internal threads on a proximal end engaged with the external threads of the second stud such that a portion of the protrusion 122 is captured between the flange of the second stud and the second anchor. The second anchor includes second internal threads on a distal end.

In some embodiments, the 3D-printed dental appliance further includes a hardware component having a first fastener and a second fastener. The hardware component may be mechanically affixed to the first anchor by the first fastener and mechanically affixed to the second anchor by the second fastener. For example, the 3D-printed dental appliance may be a Herbst appliance. Typical hardware components for such an appliance are depicted in FIG. 2. For example, the hardware component may include a piston affixed to the first anchor by a screw and pivot and to the second anchor by another screw and pivot.

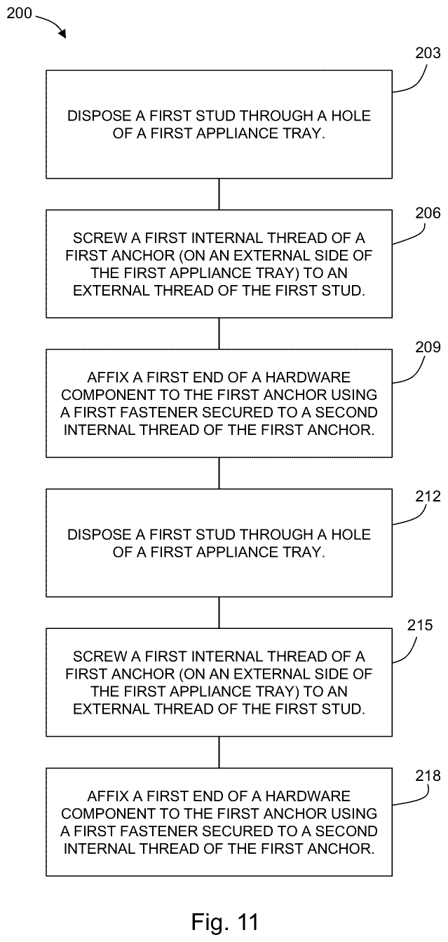

With reference to FIG. 11, in another aspect, the present disclosure may be embodied as a method 200 of securing a hardware component to a 3D-printed dental appliance. The method includes disposing 203 a first stud through a hole of a first appliance tray such that a flange of the first stud is on an internal side of the first appliance tray. A first internal thread of a first anchor is screwed (i.e., secured) 206 to an external thread of the first stud. The first anchor is located on an external side of the first appliance tray. In this way, a portion of the first appliance tray is captured between the first anchor and the flange of the first stud. A first end of a hardware component is affixed 209 to the first anchor by way of a first fastener secured to a second internal thread of the first anchor.

In some embodiments, the method 200 further includes disposing 212 a second stud through a hole of a second appliance tray such that a flange of the second stud is on an internal side of the second appliance tray. A first internal thread of a second anchor is screwed (i.e., secured) 215 to an external thread of the second stud. The second anchor is located on an external side of the second appliance tray. In this way, a portion of the second appliance tray is captured between the second anchor and the flange of the second stud. A second end of the hardware component is affixed 218 to the second anchor by way of a second fastener secured to a second internal thread of the second anchor.

Although the present disclosure has been described with respect to one or more particular embodiments, it will be understood that other embodiments of the present disclosure may be made without departing from the spirit and scope of the present disclosure.

We claim:

1. A 3D-printed dental appliance, comprising:
a first appliance tray configured to cover at least a portion of a first dental arch of an individual, the first appliance tray having a protrusion at a hardware attachment location;
a first stud disposed on an internal side of the protrusion of the first appliance tray, the first stud having a flange on a proximal end and external threads disposed through a hole of the protrusion; and
a first anchor disposed on an external side of the protrusion, the first anchor having first internal threads on a proximal end engaged with the external threads of the first stud such that a portion of the protrusion is captured between the flange of the first stud and the first anchor, and wherein the first anchor includes second internal threads on a distal end.

2. The 3D-printed dental appliance of claim 1, further comprising a fastener joined with the second internal threads of the first anchor.

3. The 3D-printed dental appliance of claim 1, wherein the first stud and the first anchor are made from a plastic.

4. The 3D-printed dental appliance of claim 3, wherein the plastic is nylon.

5. The 3D-printed dental appliance of claim 1, wherein the external threads of the first stud and/or the first internal threads of the first anchor include an adhesive.

6. The 3D-printed dental appliance of claim 1, further comprising:
a second appliance tray configured to cover at least a portion of a second dental arch of an individual, the second appliance tray having a protrusion at a hardware attachment location;
a second stud disposed on an internal side of the protrusion of the second appliance tray, the second stud having a flange on a proximal end and external threads disposed through a hole of the protrusion; and
a second anchor disposed on an external side of the protrusion, the second anchor having first internal threads on a proximal end engaged with the external threads of the second stud such that a portion of the protrusion is captured between the flange of the second stud and
the second anchor, and wherein the second anchor includes second internal threads on a distal end.

7. The 3D-printed dental appliance of claim 6, further comprising a hardware component having a first fastener and a second fastener, wherein the hardware component is mechanically affixed to the first anchor by the first fastener and mechanically affixed to the second anchor by the second fastener.

8. A Herbst appliance comprising a 3D-printed dental appliance according to claim 1.

9. A boss assembly for attachment of hardware components to a dental appliance, comprising:
an anchor configured to be disposed on an external side of a dental appliance, the anchor having first internal threads on a proximal end, and second internal threads on a distal end, and wherein the second internal threads are configured to cooperate with external threads of a hardware component;
a stud configured to be disposed on an internal side of a dental appliance, the stud having a flange on a proximal end and external threads configured to cooperate with the first internal threads of the anchor; and
wherein the anchor and the stud are configured to join such that a wall of the dental appliance is captured between the anchor and the flange of the stud.

10. The boss assembly of claim 9, wherein the anchor further comprises a flange on the proximal end.

11. The boss assembly of claim 9, wherein the anchor and the stud are made from plastic.

12. The boss assembly of claim 11, wherein the anchor and the stud are made from nylon.

13. The boss assembly of claim 9, wherein the external threads of the stud and/or the first internal threads of the anchor include an adhesive

14. The boss assembly of claim 9, wherein the anchor has a plurality of side walls configured to accept a tool.

15. The boss assembly of claim 9, wherein the flange of the stud has a plurality of side walls configured to accept a tool.

16. The boss assembly of claim 9, wherein the proximal end of the stud includes a shaped cavity configured to accept a drive tool.

17. The boss assembly of claim 9, wherein the external threads of the stud and/or the first internal threads of the anchor include an adhesive.

18. The boss assembly of claim 17, wherein the adhesive is reversible or irreversible.

19. A method of securing a hardware component to a 3D printed dental appliance, the method comprising:
disposing a first stud through a hole of a first appliance tray such that a flange of the first stud is on an internal side of the first appliance tray;
screwing a first internal thread of a first anchor on an external side of the first appliance tray to an external thread of the first stud such that a portion of the first appliance tray is captured between the first anchor and the flange of the first stud; and
affixing a first end of a hardware component to the first anchor using a first fastener secured to a second internal thread of the first anchor.

20. The method of claim 19, wherein the hole of the first appliance tray is located on a protrusion.

21. The method of claim 19, wherein the first stud and the first anchor are made from nylon.

22. The method of claim 19, further comprising:
disposing a second stud through a hole of a second appliance tray such that a flange of the second stud is on an internal side of the second appliance tray;
screwing a first internal thread of a second anchor on an external side of the second appliance tray to an external thread of the second stud such that a portion of the second appliance tray is captured between the second anchor and the flange of the second stud; and
affixing a second end of the hardware component to the second anchor using a second fastener secured to a second internal thread of the second anchor.
